(19) United States
(12) Patent Application Publication
(10) Pub. No.: US 2017/0061636 A1
(43) Pub. Date: Mar. 2, 2017

(54) SHAPE RECOGNITION

(71) Applicant: Konica Minolta Laboratory U.S.A., Inc., San Mateo, CA (US)

(72) Inventor: Kurt Nathan Nordback, Portland, OR (US)

(73) Assignee: Konica Minolta Laboratory U.S.A., Inc., San Mateo, CA (US)

(21) Appl. No.: 14/835,226

(22) Filed: Aug. 25, 2015

(51) Int. Cl. G06T 7/00; G06K 9/46; G06K 9/62; G06T 7/60; G06K 9/52

(52) U.S. Cl. CPC G06T 7/0065; G06T 7/60; G06K 9/52; G06K 9/6201; G06K 9/4642; G06K 9/4604; G06K 9/6267

(57) ABSTRACT

A method for computer recognition of a shape described by a path. The method includes: obtaining a parameterized version of the path having a plurality of points; calculating a plurality of tangent angles for the plurality of points; determining a distribution for the plurality of tangent angles; obtaining a plurality of reference distributions for a plurality of reference shapes; comparing the distribution with the plurality of reference distributions; and matching, based on the comparing, the shape to one of the plurality of reference shapes.

### BACKGROUND

Shape recognition is important in many technological fields including computer vision, medical imaging, security applications, computer-aided design and manufacturing, etc. A human can easily recognize a visual object in the shape of a horse, for instance, even if the object lacks other details or is two-dimensional, in an unexpected color or pattern (purple, spotted like a leopard, etc.), rotated, etc. Computer implemented shape recognition should have the same capability, being able to recognize an object by its shape while being relatively insensitive to other properties.

Various algorithms have been developed to simplify computerized recognition of shapes. For instance, several algorithms are based on computing shape moments. Other algorithms are based on shape diameters or ratio of area to perimeter. Each algorithm has disadvantages. Regardless, computer shape recognition remains important in many technological fields.

### SUMMARY

In general, in one aspect, the invention relates to a method for computer recognition of a shape described by a path. The method comprises: obtaining a parameterized version of the path comprising a plurality of points; calculating a plurality of tangent angles for the plurality of points; determining a distribution for the plurality of tangent angles; obtaining a plurality of reference distributions for a plurality of reference shapes; comparing the distribution with the plurality of reference distributions; and matching, based on the comparing, the shape to one of the plurality of reference shapes.

In general, in one aspect, the invention relates to a non-transitory computer readable medium (CRM) storing computer readable program code embodied therein that: obtains a parameterized version of a path describing a shape, the path comprising a plurality of points; calculates a plurality of tangent angles for the plurality of points; determines a distribution for the plurality of tangent angles; obtains a plurality of reference distributions for a plurality of reference shapes; compares the distribution with the plurality of reference distributions; and matches, based on the comparison, the shape to one of the plurality of reference shapes.

In general, in one aspect, the invention relates to a system for performing computer recognition of a shape described by a path. The system comprises: a parameterizing engine that generates a parameterized version of the path comprising a plurality of points; a tangent angle engine that: calculates a plurality of tangent angles for the plurality of points; and determines a distribution for the plurality of tangent angles; a reference repository storing a plurality of reference distributions for a plurality of reference shapes; and a matching engine that: compares the distribution with the plurality of reference distributions; and matches, based on the comparison, the shape to one of the plurality of reference shapes.

Other aspects of the invention will be apparent from the following description and the appended claims.

### BRIEF DESCRIPTION OF DRAWINGS

FIG. 1 shows a system in accordance with one or more embodiments of the invention.

FIG. 2 shows a flowchart in accordance with one or more embodiments of the invention.

FIG. 3A and 3B show examples in accordance with one or more embodiments of the invention.

FIG. 4 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention provide a method, a non-transitory computer readable medium (CRM), and a system for performing computer recognition of a shape described by a path. The path may be an open path or a closed path. Once the path is parameterized, tangent angles for the points of the path are calculated and a distribution of the tangent angles is determined. This distribution is compared against reference distributions corresponding to reference shapes in order to match the shape to one of the reference shapes. The distribution and reference distributions may be histograms. Further, the histogram of the shape may be circular shifted in order to perform the comparison.

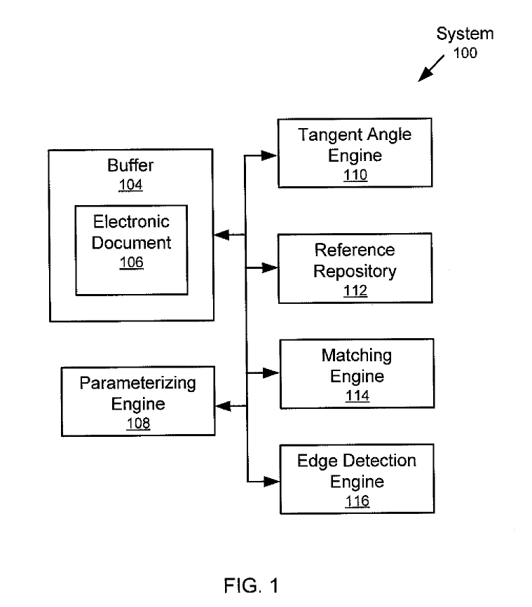

FIG. 1 shows a system (100) in accordance with one or more embodiments of the invention. As shown in FIG. 1, the system (100) has multiple components including, for example, a buffer (104), a parameterizing engine (108), a tangent angle engine (110), a reference repository (112), a matching engine (114), and an edge detection engine (116). Each of these components (104, 108, 110, 112, 114, 116) is discussed below. Moreover, each of the components may be located on the same hardware device (e.g., smart phone, tablet PC, laptop, e-reader, desktop personal computer (PC), kiosk, server, mainframe, cable box, etc.) or may be located on different hardware devices connected by a network of any size having wired and/or wireless segments.

In one or more embodiments of the invention, the system (100) includes the buffer (104). The buffer (104) may be of any size. The buffer (104) may be implemented in hardware (i.e., circuitry), software, or any combination thereof. The buffer (104) stores an electronic document (ED) (106) obtained/downloaded from any source including sources external to the system (100). The ED (106) may be a word processing document, a slide presentation, a photograph, an image, or any other type of file comprising one or more shapes. Each shape may be referred to as an unknown shape or candidate shape as the shape has not yet been matched to a reference shape (discussed below).

In one or more embodiments of the invention, the system (100) includes the edge detection engine (116). The edge detection engine (116) may be implemented in hardware (i.e., circuitry), software, or any combination thereof. Those skilled in the art, having the benefit of this detailed description, will appreciate that each shape in the ED (106) is described by a path. The path may correspond to the edge (e.g., perimeter, outline) of the shape. The path may be an open path or a closed path. The edge detection engine (116) is configured to apply an edge detection algorithm (e.g., Canny edge detection) to the ED (106) to identify and extract the path describing the shape.

In one or more embodiments of the invention, the system (100) includes the parameterizing engine (108). The parameterizing engine (108) may be implemented in hardware (i.e., circuitry), software, or any combination thereof. The parameterizing engine (108) is configured to generate a parameterized version of the identified/extracted path of the unknown shape. The parameterized version of the path may be continuous or discrete. For example, the parameterizing engine (108) is configured to generate a parametric equation P(t) for the path, where t is the normalized distance along the path and 0≦t≦1. If the path is closed, P(0)=P(1). If the path is open, P(0)≠P(1).

In one or more embodiments of the invention, the system (100) includes the tangent angle engine (110). The tangent angle engine (110) may be implemented in hardware (i.e., circuitry), software, or any combination thereof. The tangent angle engine (110) is configured to calculate a tangent angle θ(t) for each point on the parameterized version of the path for which the tangent angle is defined. Those skilled in the art, having the benefit of this detailed description, will appreciate that the tangent angle of a curve (i.e., the parameterized version of the path) in the Cartesian plane, at a specific point, is the angle between the tangent line to the curve at the given point and the x-axis. If a point on the parameterized path is expressed as (x(t), y(t)), then the tangent angle φ at t is defined as:

$$( cos ϕ , sin ϕ ) = \frac{( {x}^{′} ( t ) , {y}^{′} ( t ) )}{\vert {x}^{′} ( t ) , {y}^{′} ( t ) \vert}$$

where the prime symbol denotes derivative.

In one or more embodiments of the invention, the tangent angle engine (110) is configured to determine a distribution of the calculated tangent angles. If the parameterized version of the path is continuous, a tangent angle distribution function may be calculated as:

Q(φ)=μ({t|θ(t)<φ})

where 0≦φ≦π and μ is the set measurement function. Accordingly, the tangent angle density function (i.e., the distribution) may then be calculated as: q(φ)=≢Q/≢φ. If the parameterized version of the path is discretized, the tangent angles can be binned. In such embodiments, the distribution is a histogram of the tangent angle values.

In one or more embodiments of the invention, the system (100) includes the reference repository (112). The reference repository (112) may be implemented using any type of data structure (e.g., array, linked-list, lookup table, etc.) or memory hardware. The reference repository (112) stores reference distributions for a set of reference shapes (discussed below). Each reference distribution may be a histogram (i.e., reference histogram) of the tangent angles of the corresponding reference shape. Additionally or alternatively, each reference distribution may be the tangent angle density function for the corresponding reference shape.

In one or more embodiments of the invention, the system (100) includes the matching engine (114). The matching engine (114) may be implemented in hardware (i.e., circuitry), software, or any combination thereof. The matching engine (114) is configured to execute a comparison of the determined distribution with the reference distributions and match the unknown shape described by the path to one of the reference shapes. As discussed above, both the determined distribution and the reference distributions may be histograms. Accordingly, executing the comparison may include calculating a chi-square distance, an intersection, and/or a Bhattacharyya distance between the histogram of the tangent angles for the unknown shape and the plurality of reference histograms.

Those skilled in the art, having the benefit of this detailed description, will appreciate that when a shape is rotated, the histogram of tangent angles for the shape undergoes a circular shift. Accordingly, executing the comparison may include performing one or more circular shifts of the histogram corresponding to the unknown shape before it is compared with the reference histograms.

Although the system (100) in FIG. 1 is shown as having six components, those skilled in the art, having the benefit of this detailed description, will appreciate that one or more of the components may be duplicated, while two or more of the components may be collapsed into a single component. Further, the system (100) may have additional components that are not shown.

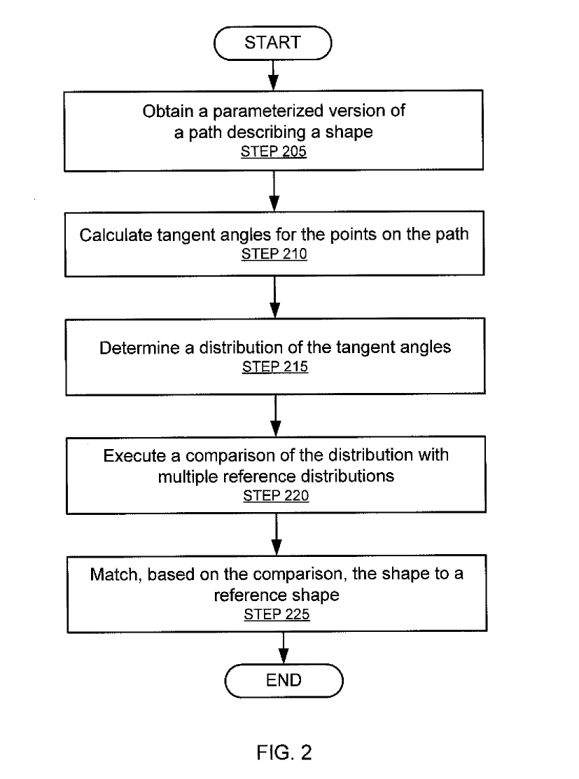

FIG. 2 shows a flowchart in accordance with one or more embodiments of the invention. The flowchart depicts a process for performing computer recognition of a shape described by a path. One or more of the steps in FIG. 2 may be performed by the components of the system (100), discussed above in reference to FIG. 1. In one or more embodiments of the invention, one or more of the steps shown in FIG. 2 may be omitted, repeated, and/or performed in a different order than the order shown in FIG. 2. Accordingly, the scope of the invention should not be considered limited to the specific arrangement of steps shown in FIG. 2.

Initially, a parameterized version of the path describing the shape is obtained (STEP 205). The shape may be located in an ED and the path describing the shape may be identified/extracted by performing edge detection on the ED. Additionally or alternatively, the parameterized version of the path may be provided to the process depicted in FIG. 2 by a software function that calls the process depicted in FIG. 2. Further, the path may be an open path or a closed path. The parameterized version of the path may be continuous or discrete.

In STEP 210, a tangent angle is calculated for each point (or a subset of the points) on the parameterized version of the path for which the tangent angle is defined. As discussed above, the tangent angle of a curve (i.e., the parameterized version of the path) in the Cartesian plane, at a specific point, is the angle between the tangent line to the curve at the given point and the x-axis.

In STEP 215, a distribution of the tangent angles is determined. If the parameterized version of the path is continuous, the determined distribution may be the tangent angle density function. If the parameterized version of the path is discrete, the determined distribution may be a histogram with the tangent angles binned.

In STEP 220, a comparison of the determined distribution with multiple reference distributions is executed. When the determined distribution and the reference distribution are histograms, the comparison may include calculating an intersection, a chi-square distance, and/or a Bhattacharyya distance between the determined histogram and the reference histograms. In one or more embodiments of the invention, one or more circular shifts are applied to the determined histogram of tangent angles to account for a rotational offset between the unknown shape and the reference shapes. The circular shift(s) may be applied when not a single correlation between the determined distribution and the multiple reference distributions satisfies a minimum threshold (e.g., the calculated chi-square distances are too large). Following each circular shift, the now-shifted histogram of tangent angles is compared (i.e., intersection, chi-square distance, Bhattacharyya distance, etc.) with each of the reference histograms.

In STEP 225, the unknown shape is matched to one of the reference shapes. Specifically, the unknown shape is matched to the reference shape having a reference distribution of tangent angles (e.g., histogram) that most closely matches the determined distribution of tangent angles for the unknown shape (STEP 215). Differences in color or scaling factors between the unknown shape and the reference shape will be of little influence because it is the tangent angles that are used to perform the match.

The match may be reported visually (i.e., on a display screen) to a user. Additionally or alternatively, the identity of the matching reference shape may be returned to the software function that called the process depicted in FIG. 2. The match may be used with other matches performed by other shape recognition algorithms to calculate a confidence interval regarding the identity of the unknown shape.

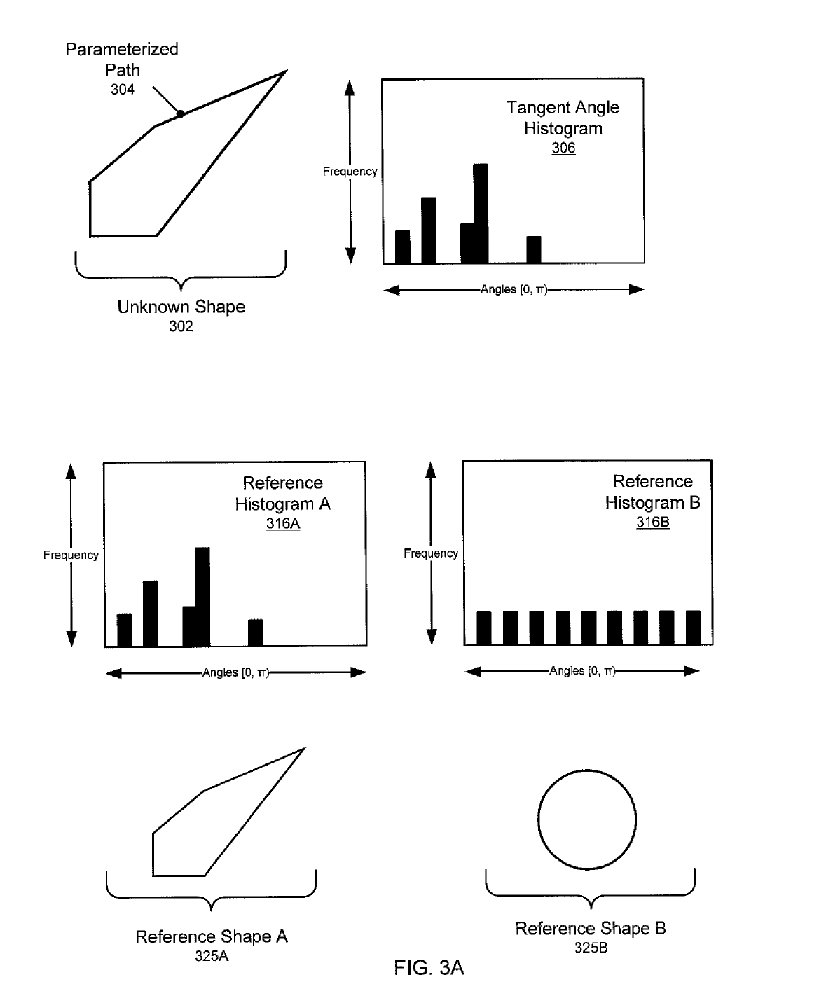

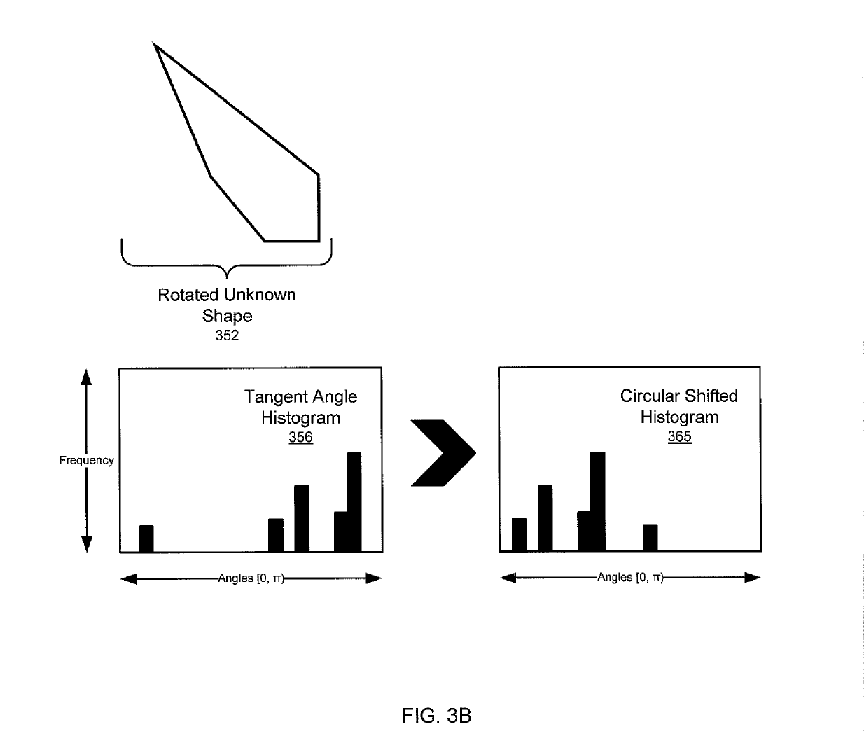

FIG. 3A shows an example in accordance with one or more embodiments of the invention. As shown in FIG. 3A, there exists an unknown shape (302). The unknown shape may be in an ED (e.g., a word processing document) (not shown). The unknown shape (302) is described by a closed path that has been extracted, using an edge detection algorithm, from the ED. A parameterized version of the path (304) is generated. Tangent angles for approximately 40 points on the parameterized version of the path (304) are calculated.

Still referring to FIG. 3A, a histogram (306) for the calculated tangent angles is determined. The horizontal axis of the histogram (306) corresponds to tangent angles between 0 and π (angles in excess of π up to 2π are mapped to [0, π)). The vertical axis of the histogram (306) corresponds to frequencies of the calculated tangent angles for the unknown shape (302).

FIG. 3A also shows two reference tangent angle histograms (i.e., Reference Histogram A (316A), Reference Histogram B (316B)) that correspond to two reference shapes (i.e., Reference Shape A (325A), Reference Shape B (325B)). The reference shapes (325A, 325B) may be part of a library that has been previously selected by a user or a software function. The reference histograms (316A, 316B) for the reference shapes (325A, 325B) may have been pre-generated.

The tangent angle histogram (306) for the unknown shape (302) is compared with each of the reference histograms (316A, 316B). This comparison may include calculating an intersection, a chi-square distance, and/or a Bhattacharyya distance between this histogram (306) and the reference histograms (316A, 316B). Based on this comparison, it is determined that the histogram (306) most closely aligns with reference histogram A (316) and thus the unknown shape (302) matches reference shape A (325A).

FIG. 3B shows an example in accordance with one or more embodiments of the invention. Specifically, FIG. 3B shows a rotated unknown shape (352) that is present in an ED (not shown). FIG. 3B also shows a histogram (356) of tangent angles for the path describing the rotated unknown shape (352).

Those skilled in the art, having the benefit of this detailed description, will appreciate that the unknown shape (302) and the rotated unknown shape (352) are effectively the same shape with a rotational offset. Accordingly, the unknown rotated shape (352) should also match with reference shape A (325A). However, a comparison between the histogram (356) and reference histogram A (316A) will result in a low correlation (e.g., large chi-square distance). A low correlation is also expected if the histogram (356) is compared with reference histogram B (316B).

As neither comparison (i.e., comparison between the histogram (356) and the references histograms (316A, 316B)) resulted in a high correlation, a circular shift is applied to the histogram (356) to produce the circular shifted histogram (365). The comparisons are executed again. Now, the circular shifted histogram (365) will highly correlate with reference histogram A (316A), and the unknown rotated shape (352) will be correctly matched with reference shape A (325A).

One or more embodiments of the invention may have the following advantages: the ability to use a distribution of tangent angles to match an unknown shape with a reference shape; the ability to perform computer shape recognition for a shape described by an open path; the ability to perform computer shape recognition without calculating a moment of the shape; the ability to perform computer shape recognition without calculating shape diameters; the ability to perform computer shape recognition without calculating ratios of area to perimeter; the ability to match unknown shapes to reference shapes by comparing histograms; the ability to match unknown shapes to reference shapes by applying a circular shift to a histogram; the ability to match unknown shapes to reference shapes despite different scaling factors; etc.

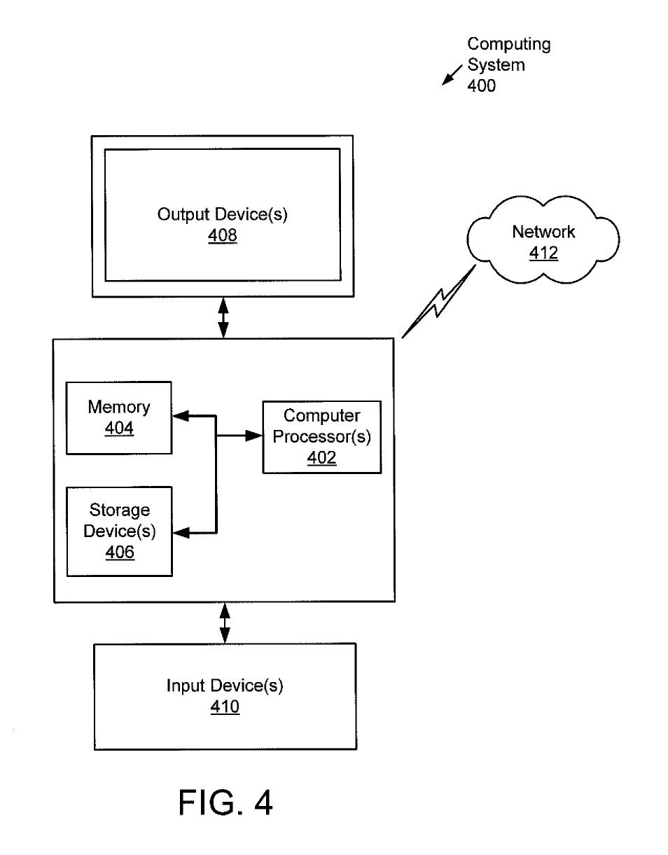

Embodiments of the invention may be implemented on virtually any type of computing system, regardless of the platform being used. For example, the computing system may be one or more mobile devices (e.g., laptop computer, smart phone, personal digital assistant, tablet computer, or other mobile device), desktop computers, servers, blades in a server chassis, or any other type of computing device or devices that includes at least the minimum processing power, memory, and input and output device(s) to perform one or more embodiments of the invention. For example, as shown in FIG. 4, the computing system (400) may include one or more computer processor(s) (402), associated memory (404) (e.g., random access memory (RAM), cache memory, flash memory, etc.), one or more storage device(s) (406) (e.g., a hard disk, an optical drive such as a compact disk (CD) drive or digital versatile disk (DVD) drive, a flash memory stick, etc.), and numerous other elements and functionalities. The computer processor(s) (402) may be an integrated circuit for processing instructions. For example, the computer processor(s) may be one or more cores, or micro-cores of a processor. The computing system (400) may also include one or more input device(s) (410), such as a touchscreen, keyboard, mouse, microphone, touchpad, electronic pen, or any other type of input device. Further, the computing system (400) may include one or more output device(s) (408), such as a screen (e.g., a liquid crystal display (LCD), a plasma display, touchscreen, cathode ray tube (CRT) monitor, projector, or other display device), a printer, external storage, or any other output device. One or more of the output device(s) may be the same or different from the input device(s). The computing system (400) may be connected to a network (412) (e.g., a local area network (LAN), a wide area network (WAN) such as the Internet, mobile network, or any other type of network) via a network interface connection (not shown). The input and output device(s) may be locally or remotely (e.g., via the network (412)) connected to the computer processor(s) (402), memory (404), and storage device(s) (406). Many different types of computing systems exist, and the aforementioned input and output device(s) may take other forms.

Software instructions in the form of computer readable program code to perform embodiments of the invention may be stored, in whole or in part, temporarily or permanently, on a non-transitory computer readable medium such as a CD, DVD, storage device, a diskette, a tape, flash memory, physical memory, or any other computer readable storage medium. Specifically, the software instructions may correspond to computer readable program code that when executed by a processor(s), is configured to perform embodiments of the invention.

Further, one or more elements of the aforementioned computing system (400) may be located at a remote location and connected to the other elements over a network (412). Further, one or more embodiments of the invention may be implemented on a distributed system having a plurality of nodes, where each portion of the invention may be located on a different node within the distributed system. In one embodiment of the invention, the node corresponds to a distinct computing device. Alternatively, the node may correspond to a computer processor with associated physical memory. The node may alternatively correspond to a computer processor or micro-core of a computer processor with shared memory and/or resources.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for computer recognition of a shape described by a path, comprising:
obtaining a parameterized version of the path comprising a plurality of points;
calculating a plurality of tangent angles for the plurality of points;
determining a distribution for the plurality of tangent angles;
obtaining a plurality of reference distributions for a plurality of reference shapes;
comparing the distribution with the plurality of reference distributions; and
matching, based on the comparing, the shape to one of the plurality of reference shapes.

2. The method of claim 1, wherein the path is an open path.

3. The method of claim 1, wherein the distribution is a histogram, and each of the plurality of reference distributions is a reference histogram.

4. The method of claim 3, further comprising:
circular shifting the distribution before the comparing of the distribution with the plurality of reference distributions.

5. The method of claim 3, wherein the comparing comprises:
calculating at least one selected from a group consisting of a chi-square distance and a Bhattacharyya distance between the distribution and each of the plurality of reference distributions.

6. The method of claim 3, wherein the comparing comprises:
calculating an intersection between the distribution and each of the plurality of reference distributions.

7. The method of claim 1, further comprising:
obtaining an electronic document (ED) comprising the shape; and
identifying the path by executing edge detection on the ED.

8. The method of claim 1, wherein the distribution is a tangent angle density function.

9. A non-transitory computer readable medium (CRM) storing computer readable program code embodied therein that:
obtains a parameterized version of a path describing a shape, the path comprising a plurality of points;
calculates a plurality of tangent angles for the plurality of points;
determines a distribution for the plurality of tangent angles;
obtains a plurality of reference distributions for a plurality of reference shapes;
compares the distribution with the plurality of reference distributions; and
matches, based on the comparison, the shape to one of the plurality of reference shapes.

10. The non-transitory CRM of claim 9, wherein the path is an open path.

11. The non-transitory CRM of claim 9, wherein the distribution is a histogram, and each of the plurality of reference distributions is a reference histogram.

12. The non-transitory CRM of claim 11, further storing computer readable program code embodied therein that:
circular shifts the distribution before the comparison of the distribution with the plurality of reference distributions.

13. The non-transitory CRM of claim 11, wherein the comparison comprises:
calculating at least one selected from a group consisting of a chi-square distance and a Bhattacharyya distance between the distribution and each of the plurality of reference distributions.

14. The non-transitory CRM of claim 11, wherein the comparison comprises:
calculating an intersection between the distribution and each of the plurality of reference distributions.

15. The non-transitory CRM of claim 9, further storing computer readable program code embodied therein that:
obtains an electronic document (ED) comprising the shape; and
identifies the path by executing edge detection on the ED.

16. The non-transitory CRM of claim 9, wherein the distribution is a tangent angle density function.

17. A system for performing computer recognition of a shape described by a path, comprising:
a parameterizing engine that generates a parameterized version of the path comprising a plurality of points;
a tangent angle engine that:
calculates a plurality of tangent angles for the plurality of points; and
determines a distribution for the plurality of tangent angles;
a reference repository storing a plurality of reference distributions for a plurality of reference shapes; and
a matching engine that:
compares the distribution with the plurality of reference distributions; and
matches, based on the comparison, the shape to one of the plurality of reference shapes.

18. The system of claim 17, wherein the path is an open path.

19. The system of claim 17, wherein:
the distribution is a histogram;
each of the plurality of reference distributions is a reference histogram; and
the comparison comprises calculating at least one selected from a group consisting of a chi-square distance and a Bhattacharyya distance between the distribution and each of the plurality of reference distributions.

20. The system of claim 17, further comprising:
a buffer storing an electronic document (ED) comprising the shape; and
an edge detection engine that identifies the path from the ED comprising the shape.
